(19) United States
(12) Patent Application Publication
(10) Pub. No.: US 2026/0291337 A1
(43) Pub. Date: Sep. 24, 2026

(54) ELECTRIC DRIVE UNIT OF A VEHICLE

(71) Applicant: ZF CV Systems Global GmbH, Bern (CH)

(72) Inventors: Tobias KORTLANG, Gehrden (DE); Tobias KOCH, Hannover (DE)

(21) Appl. No.: 19/546,596

(22) Filed: Feb. 23, 2026

(30) Foreign Application Priority Data
Mar. 24, 2025 (DE) 102025111280.0

(51) Int. Cl. H02K 9/19; H02K 5/20; H02K 11/33

(52) U.S. Cl. CPC H02K 9/19; H02K 5/203; H02K 11/33

(57) ABSTRACT

An electric drive unit of a vehicle, includes an electric machine, which has a motor housing and at least one cooling channel, which is arranged at least partially on the motor housing and through which a liquid coolant can flow, and including an electronic control unit, which has a control housing attached to the motor housing, in which control housing at least one circuit board equipped with power semiconductors is attached, and in which the power semiconductors are also arranged in a manner that enables them to be cooled by means of the coolant. To improve the cooling at least of the power semiconductors, this drive unit provides that, in the region of its wall which is adjacent to the motor housing, the control housing has an inlet-side cooling channel section fluidically connected to the cooling channel of the motor housing, that this cooling channel section is designed in such a way that it is open perpendicularly to the direction of flow of the coolant in the direction of that end face of the motor housing which is adjacent to the control device, that this cooling channel section is covered fluid-tightly by the motor housing, that this cooling channel section is fluid-tightly delimited, at least opposite its open region, by a cooling channel wall formed on the control housing and extending in the direction of flow, that, adjacent to the cooling channel section the circuit board extends in a manner remote from the fluid, parallel to and at a distance from the cooling channel wall of the control housing, and that the component side of the circuit board with the power semiconductors arranged there faces the cooling channel wall of the control housing.

### TECHNICAL FIELD

The invention relates to an electric drive unit of a vehicle, comprising an electric machine, which has a motor housing and at least one cooling channel, which is arranged at least partially on the motor housing and through which a liquid coolant can flow, and comprising an electronic control unit, which has a control housing attached to the motor housing, in which control housing at least one circuit board equipped with power semiconductors is attached, and in which the power semiconductors are also arranged in a manner that enables them to be cooled by means of the coolant.

### BACKGROUND OF THE INVENTION

An electric machine of an electric or hybrid vehicle can be operated alternately as a motor or as a generator. For this purpose, the associated electronic control unit has control electronics and power electronics (inverter). The control electronics are used to determine the driving status of the vehicle as well as the power requirement of a driver, and the power electronics are controlled according to these specifications. In the power electronics, which have power semiconductors, in particular power transistors, such as MOSFETs (Metal Oxide Semiconductor Field-Effect Transistor), IGBTs (Insulated Gate Bipolar Transistor) and/or HEMTs (High Electronic Mobility Transistor), the DC current of a traction battery is converted into a multi-phase alternating current of the electric machine during motor operation of the electric machine, and the multi-phase alternating current of the electric machine is converted into a direct current of the traction battery during generator operation of the electric machine. As the power semiconductors heat up comparatively strongly owing to the high electrical currents flowing during this process, it is necessary to cool them to avoid temperature-related malfunctions and damage. Owing to their good heat transfer capacity and high heat capacity, liquid coolants are preferred for cooling the power semiconductors.

DE 198 17 333 C1 discloses an electronic drive unit of a vehicle in which a common cooling circuit is provided for cooling the electric machine and the electronic control unit. The control housing of the electronic control unit is attached tangentially to the motor housing of the electric machine by means of an opening in such a way that a cooling insert connected to a cooling channel of the electric machine engages in the opening.

DE 10 2014 016 171 A1 describes an electric drive unit of a vehicle in which the control housing of the electronic control unit is attached tangentially, via a full-surface heat conducting element, such as a heat conducting foil or a heat conducting adhesive, to the motor housing of the electric machine, which housing is provided with a circumferential cooling channel.

DE 10 2017 202 970 A1, on the other hand, discloses an electric drive unit for stationary applications, in which the control housing of the electronic control unit is attached tangentially to the motor housing of the electric motor via a cooling plate, through which a cooling channel passes, wherein the cooling channel of the cooling plate is connected upstream of and in series with a cooling channel of the electric motor.

Whereas in the case of the above-mentioned electric drive units, the power semiconductors of the electronic control units are cooled by the coolant of the electric machine only indirectly, i.e. by means of heat radiation and convection of the air trapped in the control housing, a heat sink in contact with circuit boards is provided for cooling the power semiconductors in an electronic control unit of an electric drive unit of a vehicle according to DE 10 2020 216 316 A1. In the heat sink, a plurality of cooling channels, which can be passed through by a liquid coolant and each of which is assigned to one phase of the inverter semiconductors, is arranged in parallel with separate inlet and outlet channels.

DE 10 2019 214 565 A1, on the other hand, describes an electronic control unit of an electric drive unit of a vehicle in which a liquid, electrically non-conductive coolant can flow directly through the control housing in order to cool the power semiconductors.

In a similar cooling arrangement of an electronic control unit with direct flow of a coolant through the control housing according to DE 10 2023 206 563 A1, it is provided that part of the coolant is initially passed over a first circuit board equipped with power semiconductors and another part of the coolant is directed past it at a distance, and that after passing through a transfer element, the other part of the coolant is passed over a second circuit board equipped with power semiconductors and the first part of the coolant is directed past it at a distance.

### SUMMARY OF THE INVENTION

In view of the risk of leaks in the case of cooling channels that run completely through the control housing and of temperature-related corrosion damage to conductor tracks and contacts of semiconductors when a coolant flows through the control housing, the object to be achieved by the present invention consists in presenting an electric drive unit of a vehicle of the above type having an effective, permanently reliable cooling device for the power semiconductors of the electronic control unit, which device can be produced at low cost.

This object is achieved by a drive unit of a vehicle having the features of claim 1. Advantageous refinements are defined in the dependent claims.

Accordingly, the invention relates to an electric drive unit of a vehicle, comprising an electric machine, which has a motor housing and at least one cooling channel, which is arranged at least partially on the motor housing and through which a liquid coolant can flow, and comprising an electronic control unit, which has a control housing attached to the motor housing, in which control housing at least one circuit board equipped with power semiconductors is attached, and in which the power semiconductors are also arranged in a manner that enables them to be cooled by means of the coolant.

In order to solve the aforementioned problem, it is provided in this drive unit that, in that region of its wall which is adjacent to the motor housing, the control housing has an inlet-side cooling channel section fluidically connected to the cooling channel of the motor housing, that this cooling channel section is designed in such a way that it is open perpendicularly to the direction of flow of the coolant in the direction of that end face of the motor housing which is adjacent to the control device, that this cooling channel section is covered fluid-tightly by the motor housing, that this cooling channel section is fluid-tightly delimited, at least opposite its open region, by a cooling channel wall formed on the control housing and extending in the direction of flow, that, adjacent to the cooling channel section the circuit board extends in a manner remote from the fluid, parallel to and at a distance from the cooling channel wall of the control housing, and that the component side of the circuit board with the power semiconductors arranged there faces the cooling channel wall of the control housing.

By virtue of the formation of an inlet-side cooling channel section of the cooling channel of the drive unit in the control housing, the wall of the cooling channel section and that end face of the motor housing which is adjacent to the control device are effective as heat sinks during the operation of the drive unit, and therefore it is possible to dispense with a separate heat sink for the electronic components, in particular for the power semiconductors, saving manufacturing costs. The comparatively large surface area of the inlet-side cooling channel section and the directly adjacent end face of the motor housing ensure particularly good heat dissipation from the power semiconductors into the liquid coolant and into the motor housing.

Owing to the claimed arrangement of the circuit board, the power semiconductors placed there are optimally cooled at least by heat radiation, but primarily by convection in the coolant conducted in the cooling channel. This is mainly because the coolant is still cold on the inlet side and is passed through the motor housing to cool the electric machine only after passing through the inlet-side section of the cooling channel.

In further development of the invention, a further improvement of the cooling of the power semiconductors can be achieved in that, at least in the region of the power semiconductors, the cooling channel wall of the control housing has a bulge or dent directed toward the circuit board, and in that, in the region of this bulge or dent, the power semiconductors are thermally in contact with the cooling channel wall of the control housing owing to the arrangement of a heat conducting means. Thus, the power semiconductors are cooled even more effectively by the dissipation of the heat into the coolant via the heat conducting means and the cooling channel wall of the control housing. For example, thermal pads and/or thermal paste are used as heat conducting means.

In order that no dead water flow with low heat dissipation occurs in the bulge of the cooling channel, but that there is a particularly good flow of coolant through this region of the cooling channel too, provision is made in respect of the variant with the aforementioned bulge, for a cross bar projecting into the flow channel region of the bulge of the cooling channel wall of the control housing to be arranged to guide the flow of the coolant and thus ensure optimal cooling of the power semiconductors, said cross bar being attached to or formed on that end face of the motor housing which faces the control unit.

The control housing is preferably closable by means of a removable cover, ensuring that the power semiconductors are protected against environmental influences.

According to another further development of the electric drive unit having the features of the invention, it is provided that the inlet-side cooling channel section in the control housing has a substantially trough-shaped cross-sectional geometry, that the inlet-side cooling channel section is covered fluid-tightly by a flat end face of the motor housing, which end face faces the control housing, and that a passage opening for the coolant to flow through into the motor-side cooling channel is formed in the end face of the motor housing in the region of the inlet-side cooling channel section.

This variant is comparatively simple and cost-effective to manufacture because the inlet-side cooling channel section is trough-shaped and formed exclusively in the control housing. Such a control housing can be produced comparatively easily as a one-piece light-metal casting, especially since this material has a high thermal conductivity.

As an alternative to the design just described, it can be provided that a trough-shaped cooling channel section is formed in that end face of the control housing which faces the motor housing and in that end face of the motor housing which faces the control housing, that the two trough-shaped cooling channel sections are designed and arranged in a geometrically identical manner in such a way that, in the assembled state, they jointly form a tubular cooling channel section, and that a passage opening for the coolant to flow through into the motor-side cooling channel is formed in the trough-shaped cooling channel section of the motor housing.

This design has the advantage that, through the formation of a trough-shaped cooling channel section also in that end face of the motor housing which is adjacent to the control device, the surface area of the motor housing which is available for cooling is increased in comparison with the first variant.

### BRIEF DESCRIPTION OF THE DRAWINGS

The invention will be explained in more detail below with reference to exemplary embodiments illustrated in the accompanying drawing. In the drawing:

FIG. 1 shows, in a longitudinal section, a first embodiment of an electric drive unit of a vehicle according to the invention, comprising an electric machine and an electronic control unit,

FIG. 2 shows the electronic control unit according to FIG. 1 in a perspective view with a view into a trough-shaped inlet-side cooling channel section of the control housing, and

FIG. 3 shows, in a perspective view, the housing of an electric machine of the drive unit similar to that of FIG. 1, namely with a view into a trough-shaped inlet-side cooling channel section of the motor housing.

### DETAILED DESCRIPTION OF THE INVENTION

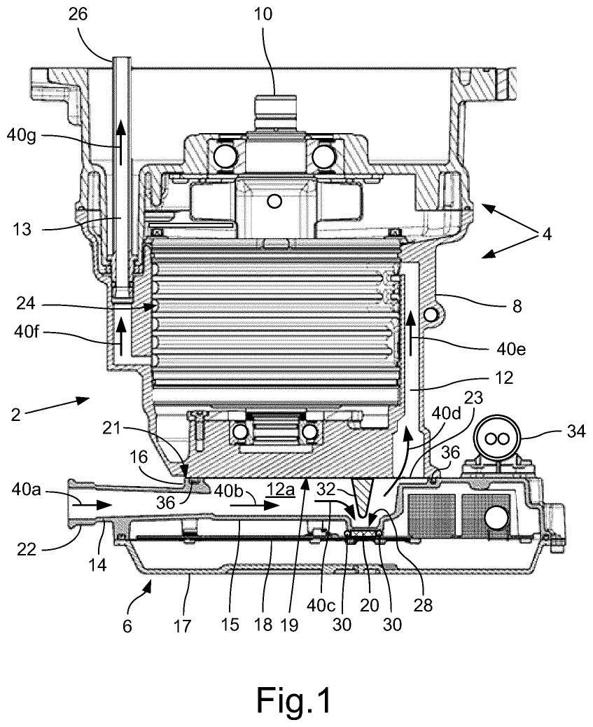

Accordingly, FIG. 1 shows, in a longitudinal section, an electric drive unit 2 of a vehicle having an electric machine 4 and an electronic control unit 6. The electric machine 4 has a motor housing 8, a drive shaft 10, which is rotatably mounted in the motor housing 8, and a cooling channel 12, which is arranged largely in the motor housing 8 and through which a liquid coolant can flow. The electronic control unit 6 has a control housing 14 and a removable cover 17 arranged thereon. Attached in the control housing 14 is a circuit board 18, on which power semiconductors 20 are arranged.

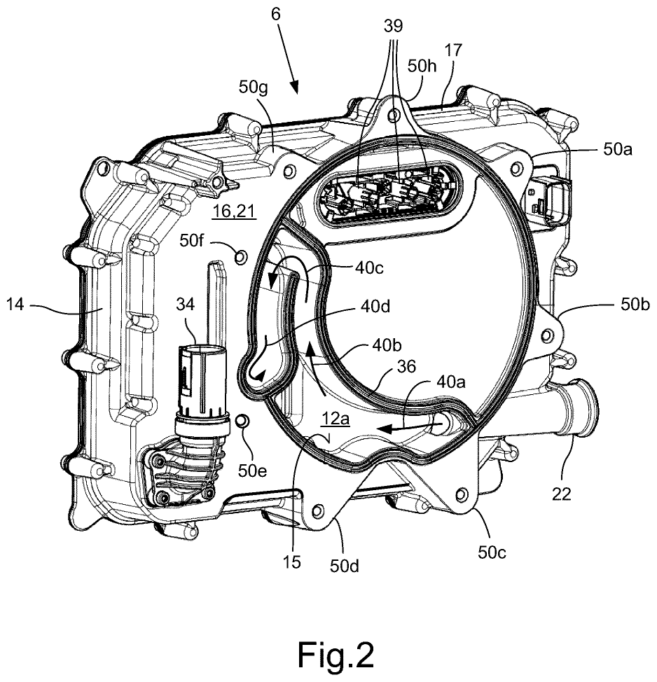

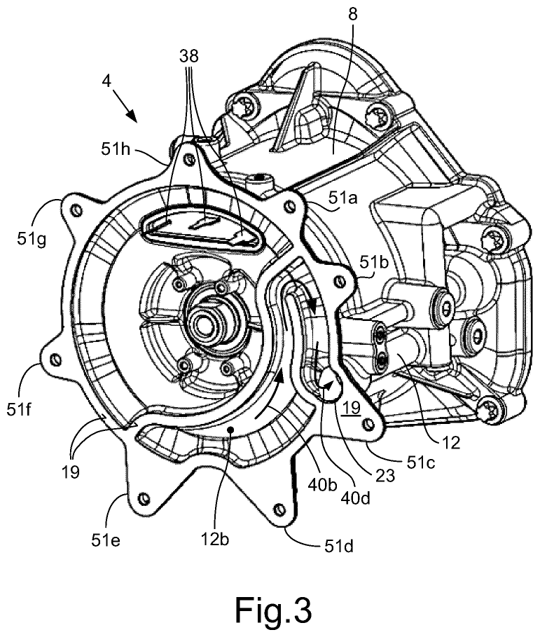

As FIGS. 2 and 3 illustrate, six ear-like projecting fastening elements 50a, 50b, 50c, 50d, 50g, 50h and two threaded holes 50e, 50f are formed on the control housing 14 in order to mechanically connect the control housing 14 to the motor housing 8. These fastening elements 50a, 50b, 50c, 50d, 50e, 50f, 50g, 50h on the control housing are assigned eight ear-like projecting fastening elements 51a, 51b, 51c, 51d, 51e, 51f, 51g, 51h on the motor housing 8. Each of the ear-like fastening elements mentioned has a hole for receiving fastening screws (not shown), with the help of which the control housing 14 can be attached removably to the motor housing 8. As a result, as FIG. 1, in particular, shows, the control housing 14 rests in the assembled state, by means of the end face 21 of its wall 16 facing the motor housing 8, against that end face 19 of the motor housing 8 which is remote from the drive shaft.

In the control housing 14, an inlet-side cooling channel section 12a is formed in the connection region just described between the motor housing 8 and the control housing 14, which section is open in the direction of the motor housing 8 and thus has a trough-shaped geometry. Since the cooling channel section 12a is of trough-shaped design, the cooling liquid can reach that end face 19 of the motor housing 8 which is adjacent to the control device and use this housing region as a cooling surface for the coolant.

For sealing this inlet-side cooling channel section 12a, at least one seal 36 in the form of a suitable sealing means is arranged between the mutually facing end faces 19, 21 of the motor housing 8 and the control housing 14. As a result, no coolant can escape from the inlet-side cooling channel section 12a.

At least in the region of the inlet-side cooling channel section 12a, the control housing 14 has a cooling channel wall 15, which delimits the cooling channel section 12a perpendicularly to the direction of flow of the cooling liquid and thereby separates the cooling liquid present in the inlet-side cooling channel section 12a from the circuit board 18 arranged in the control housing 14. In the figures, the flow path of the coolant is indicated by direction arrows 40a, 40b, 40c, 40d, 40e, 40f, 40g.

The circuit board 18 is interchangeably mounted on the side of the cooling channel wall 15 remote from the element. The circuit board 18 is arranged at a small distance parallel with respect to the cooling channel wall 15 of the control housing 14 and carries the power semiconductors 20 on its component side facing the cooling channel wall 15.

The electrical connection at least of the power semiconductors 20 with electrical components of the electric machine 4 is made via sealed electrical plug contacts 38 on the motor housing 8 and associated electrical plug contacts 39 on the control housing 14. These plug contacts 38, 39 on both sides are automatically connected to one another when the motor housing 8 and the control housing 14 are assembled.

As shown in FIGS. 1 and 2, the inlet-side cooling channel section 12a is connected on the inlet side to an inlet connector 22, through which the cooling liquid can be supplied. At the downstream end of the inlet-side cooling channel section 12a, the coolant passes via a passage opening 23 in the motor housing 8 into the cooling channel 12 there. Within the motor housing 8, this cooling channel 12 is routed, via a cooling jacket 24 comprising a plurality of separate cooling lines, to an outlet-side section 13 of the cooling channel 12 with an outlet connector 26.

FIGS. 1 and 2 also show an electrical plug socket 34 for the electrical connection of the electronic control unit 6 to an electronic on-board power supply of the vehicle. As can be seen, the plug socket 34 is attached to the motor side of the control housing 14.

FIG. 1 further shows another advantageous embodiment of the electric drive unit 2, according to which the cooling channel wall 15 has a bulge 28 or dent directed toward the circuit board 18 in the region of the power semiconductors 20, at which bulge or dent the power semiconductors 20 are in contact via heat conducting means 30, such as thermal pads and/or thermal paste, with the cooling channel wall 15 of the control housing 14. As a result, the power semiconductors 20 can transfer their waste heat generated during operation directly to the cooling channel wall 15 and from there to the coolant. For a good flow of coolant through the region of the bulge 28, a cross bar 32 projecting with an appropriate clearance into the bulge 28 is provided. This cross bar 32 is attached to or formed on that end of the motor housing 8 which is remote from the drive shaft and forces the coolant to flow through this cooling channel section according to the direction arrow 40c.

In the first variant of the electric drive unit 2, shown in FIG. 1, with the features of the invention, it is provided that an inlet-side cooling channel section 12a is formed only in the control housing 14 of the control unit 6. This inlet-side cooling channel section 12a is open in the direction of the associated end face 19 of the motor housing 8 as described and therefore formed in a trough-shaped manner. The associated end face 19 of the motor housing 8 covers this trough-shaped cooling channel section 12a in a liquid-tight manner, perpendicularly to the direction of flow 40b of the cooling liquid, with the assistance of the mentioned sealing means 36.

In the second variant, which is shown in FIGS. 2 and 3, a first trough-shaped inlet-side cooling channel section 12a is formed in the control housing 14 of the control unit 6 and a second trough-shaped inlet-side cooling channel section 12b is formed in that end face 19 of the motor housing 8 which is adjacent to the control housing. The two trough-shaped inlet-side cooling channel sections 12a, 12b are designed and arranged in a geometrically identical manner in such a way that, in the assembled state of the electric drive unit, they form a tubular inlet-side cooling channel section 12a/12b. In this second design variant, a significantly larger cooling surface for dissipating heat is available to the coolant at that end face 19 of the motor housing 8 which is adjacent to the control device than in the first design variant.

By virtue of the described arrangement of the components of the electric drive unit, the power semiconductors 20 of the electronic control unit 6 can be cooled more effectively than before with comparatively little design effort and thus damage and malfunctions of the electronic control unit 6 can be avoided.

### LIST OF REFERENCE SIGNS (PART OF THE DESCRIPTION)

2 electric drive unit
4 electric machine
6 electronic control unit
8 motor housing of the electric machine
10 drive shaft of the electric machine
12 cooling channel in the motor housing
12a inlet-side cooling channel section in control housing 14
12b inlet-side cooling channel section in motor housing 8
12a/12b tubular cooling channel section (in the assembled state)
13 outlet-side cooling channel section in motor housing 8
14 control housing
15 cooling channel wall on the control housing
16 control housing wall adjacent to the motor housing
17 cover of the control housing
18 circuit board
19 end face of the motor housing adjacent to the control device
20 power semiconductor
21 end face of the control housing wall adjacent to the motor housing
22 inlet connector on the control housing
23 passage hole in that end face of the motor housing which is adjacent to the control device
24 cooling jacket on the motor housing
26 outlet connector on the motor housing
28 bulge on the cooling channel wall of the control housing
30 heat conducting means
32 cross bar on the motor housing
34 electrical plug socket on the control housing
36 seal
38 electrical plug contacts on the motor housing
39 electrical plug contacts on the control housing
40a-40g direction arrows, direction of flow of the coolant
50a-50h fastening elements on the control housing
51a-51h fastening elements on the motor housing

1. An electric drive unit of a vehicle, comprising an electric machine, which comprises a motor housing and at least one cooling channel, which is arranged at least partially on the motor housing and through which a liquid coolant can flow, and comprising an electronic control unit, which has a control housing attached to the motor housing, in which control housing at least one circuit board equipped with power semiconductors is attached and in which the power semiconductors are also arranged in a manner that enables them to be cooled by means of the coolant, wherein, in that region of its wall which is adjacent to the motor housing, the control housing has an inlet-side cooling channel section fluidically connected to the cooling channel of the motor housing, this cooling channel section is designed in such a way that it is open perpendicularly to the direction of flow of the coolant in the direction of that end face of the motor housing which is adjacent to the control device, this cooling channel section is covered fluid-tightly by the motor housing, this cooling channel section is fluid-tightly delimited, at least opposite its open region, by a cooling channel wall formed on the control housing and extending in the direction of flow, adjacent to the cooling channel section the circuit board extends in a manner remote from the fluid, parallel to and at a distance from the cooling channel wall of the control housing, and the component side of the circuit board with the power semiconductors arranged there faces the cooling channel wall of the control housing.

2. The electric drive unit as claimed in claim 1, wherein, at least in the region of the power semiconductors the cooling channel wall of the control housing has a bulge directed toward the circuit board, and, in the region of the bulge, the power semiconductors are thermally in contact with the cooling channel wall of the control housing owing to the arrangement of a heat conducting means.

3. The electric drive unit as claimed in claim 2, wherein thermal pads and/or a thermal paste are/is arranged as heat conducting means.

4. The electric drive unit as claimed in claim 1, wherein, to guide the flow of the coolant and thus provide optimum cooling for the power semiconductors, a cross bar, which projects into the region of the bulge of the cooling channel wall of the control housing and which is attached to or formed on that end face of the motor housing which faces the control unit, is provided.

5. The electric drive unit as claimed in claim 1, wherein the inlet-side cooling channel section in the control housing has a substantially trough-shaped cross-sectional geometry, the inlet-side cooling channel section is covered fluid-tightly by a flat end face of the motor housing, which end face faces the control housing, and a passage opening for the coolant to flow through into the motor-side cooling channel is formed in the end face of the motor housing in the region of the inlet-side cooling channel section.

6. The electric drive unit as claimed in claim 1, wherein a trough-shaped cooling channel section is formed in that end face of the control housing which faces the motor housing and in that end face of the motor housing which faces the control housing, the two trough-shaped cooling channel sections are designed and arranged in a geometrically identical manner in such a way that, in the assembled state, they jointly form a tubular cooling channel section, and a passage opening for the coolant to flow through into the motor-side cooling channel is formed in the trough-shaped cooling channel section of the motor housing.

7. The electric drive unit as claimed in claim 1, wherein the control housing is manufactured as a one-piece light-metal casting part.
